(19) United States
(12) Patent Application Publication
(10) Pub. No.: US 2002/0069357 A1
(43) Pub. Date: Jun. 6, 2002

(54) Method and system for identification in a telecommunication system

(76) Inventor: Sami Kilkkila, Espoo (FI)

Correspondence Address: Altera Law Group, 6500 City West Parkway - Suite 100, Minneapolis, MN, 55344-7701, US

(21) Appl. No.: 10/057,376

(22) Filed: Jan. 24, 2002

Related U.S. Application Data
(63) Continuation of application No. PCT/FI00/00699, filed on Aug. 17, 2000.

(30) Foreign Application Priority Data
Aug. 25, 1999 (FI) 19991812

(51) Int. Cl. H04L 9/00

(52) U.S. Cl. 713/169

(57) ABSTRACT

Method for user identification and ascertainment of authenticity of parties in a telecommunication system comprising a telecommunication network; a source system connected to the telecommunication network; and a target system connected to the telecommunication network. According to the method, user identifiers and associated passwords are stored in the source system and in the target system; log-on into the source system is accomplished by entering a user identifier and a password corresponding to it; the user is identified in the source system; and a remote session to the target system is set up. In the invention, identical indexed encryption keys are generated in the source system and in the target system and the target communication between the source system and the target system is encrypted using an encryption key indicated by a given index and a kind of handshake operation is performed. By virtue of the handshake operation, the user can be identified with certainty. By using separate identification data, the source system and the target system can ascertain each other's authenticity.

### FIELD OF THE INVENTION

The present invention relates to telecommunication systems. In particular, the invention concerns a method and system for user identification and ascertainment of the authenticity of parties in a telecommunication system.

### BACKGROUND OF THE INVENTION

A telecommunication network, e.g. a telephone network, consists of a plurality of separate components interconnected via transmission lines. One of such components is a telephone exchange, which is e.g. a DX200 manufactured by the applicant. The telephone network is managed and maintained via an operation and maintenance network (O&M-network), which can be implemented e.g. on the basis of the services of an X.25 packet network. The operation and maintenance network is formed by connecting to it the telephone exchanges and other network components to be controlled. Other network components to be controlled are e.g. a transcoder (TC), a base transceiver station (BTS) and a base station controller (BSC).

From telephone network elements connected to the operation and maintenance network, it is possible to establish remote sessions to other telephone exchanges or network elements connected to the operation and maintenance network. When a remote session is being set up from a source system to a target system, user-specific data is sent to the target system for user identification. The source and target systems are e.g. telephone exchanges. The user-specific data includes e.g. a user identifier and a password associated with it. A password that is frequently sent is encrypted using a suitable encryption algorithm to prevent encroachments. The encryption algorithm is e.g. a so-called one-way algorithm. This means that it is not possible to deduce or construct the original input data from the result of encryption. Two-way algorithm means that the result of encryption can be decrypted into plain information. Decryption is generally performed using the same algorithm that was used for encryption. For decryption, either the same or a different encryption key may be used than for encryption. The former method is called symmetric encryption and the latter asymmetric encryption.

The use of encryption algorithms does improve security, but it does not eliminate all problems related to security. In some cases it is possible for an outside party to monitor a line that carries messages associated with a remote session. In such a case, the outside party may be able to capture the initial messages used in the remote session and simulate the initiation of a remote session using an encrypted password and an appropriate user identifier.

In the above-mentioned situations, the problem is how to identify the user with certainty. A further problem is that the source and target systems involved in the remote session cannot be certain about each other's authenticity.

The object of the present invention is to eliminate the drawbacks referred to above or at least to significantly alleviate them. A specific object of the invention is to disclose a new type of method that will enable reliable user identification in a target system and ascertainment of the authenticity of the systems involved in a remote session.

As for the features characteristic of the present invention, reference is made to the claims.

### BRIEF DESCRIPTION OF THE INVENTION

The method of the invention concerns user identification and ascertainment of the authenticity of parties in a telecommunication system. The telecommunication system of the invention comprises a telecommunication network and source and target systems connected to it.

In the method, the user identifiers and the associated passwords are stored in the source and target systems. Further, the user logs on into the source system by entering a user identifier and a password corresponding to it. The user is identified in the source system on the basis of the user identifier and password. Further, a remote session is set up from the source system to the target system.

According to the invention, identical, indexed encryption keys are generated in the source and target systems. The encryption keys may also be generated using a predetermined encryption algorithm e.g. on the basis of the index. The source and target systems may also contain a special encryption key list or file containing a plurality of encryption keys. In the initial stage of the establishment of a session, the password associated with the user identifier is encrypted in the source system using a password indicated by a first index, and the encrypted information as well as the first index and the user identifier are sent to the target system. Thus, the index and the user identifier need not necessarily be transmitted in an encrypted form between the systems. The index and the user identifier can be sent in an unprotected form because their publicity does not impair the security of the system as the encryption key corresponding to the index cannot be determined on the basis of the index. The index and user identifier may also be sent in an encrypted form, in which case they are encrypted using e.g. a two-way encryption algorithm. The source system may also send to the target system separate identification data, which is encrypted and sent to the target system simultaneously with the user data in accordance with the procedure described above. The identification data can also be transmitted between the source and target systems independently, apart from the user data at a different time.

The first index preferably consists of a number or item pointing at a given encryption key. The index can be selected on a random basis or it may be generated on the basis of a predetermined algorithm. This algorithm may be a secret one and only known to the source and target systems. The identification data consists of e.g. time data and/or data individualizing the source system. The time data is obtained e.g. from the system clock and the identifier individualizing the system is obtained e.g. from the configuration files.

The target system receives the message sent by the source system, preferably comprising an encrypted password, a user identifier, an index and possibly identification data. In the target system, the password corresponding to the user identifier in question is looked up in a password register and the password associated with the user identifier is encrypted using an encryption key indicated by the index. The password associated with the user identifier has been stored in the user data in the target system. The target system compares the password received password and the password it has just encrypted. If the encrypted passwords thus compared are not coincident, then the setup of the remote session can be prevented.

After this, at a second stage, the target system encrypts the password associated with the user identifier received from the source system and possibly the identification data using an encryption key indicated by a second index. The encrypted information and the second index are sent back to the source system, where the encrypted password initially sent to the target system is encrypted again using a password indicated by the second index just received from the target system. The result thus obtained is compared with the encrypted password received from the target system. If the passwords compared are not coincident, then the setup of the remote session can be prevented.

If identification data is used between the source and target systems, then the identification data initially sent to the target system and encrypted using the encryption key indicated by the first index is encrypted again in the source system using a password indicated by the second index received from the target system. In the source system, the identification data just encrypted is compared with the encrypted identification data received from the target system. If the identification data items thus compared are not coincident, then the setup of the remote session can be prevented. By using identification data, the source system can ascertain the authenticity of the target system. This is possible because the source system can send the initially encrypted identification data to the target system. If the target system is authentic, then it will send back to the source system the same identification data encrypted with a new password. Since the source system at the same time receives from the target system a second index pointing at a given encryption key, the source system is able to confirm the coincidence of the identification data items via a comparison, thereby gaining a certainty about the authenticity of the target system. It is to be understood that the identification data need not necessarily be transmitted simultaneously with the user data; instead, it can be transmitted separately at a suitable time.

If the results of the above-mentioned comparisons are coincident, then the remote session can be set up.

In an embodiment of the invention, a one-way encryption algorithm is used for the encryption of information in the source and target systems. Examples of such algorithms are MD5 (MDS, Message Digest 5) and SHA (SHA, Secure Hash Algorithm).

In an embodiment of the invention, the telecommunication system is a telephone exchange system.

In an embodiment of the invention, the source system and/or target system are telephone exchanges.

In an embodiment of the invention, the telecommunication network is an operation and maintenance network.

The system of the present invention comprises means for creating identical indexed encryption keys in the source system and in the target system, means for encrypting information in the source and target systems using an encryption key indicated by the index, and means for transmitting information between the source and target systems. Moreover, the system comprises means for performing a comparison in the source and target systems and means for approving setup of a remote session.

In an embodiment of the invention, the system comprises means for preventing the setup of a remote session. In another embodiment, the system comprises means for generating identification data and for adding time data and/or data individualizing the source system to the identification data.

In an embodiment of the invention, the system comprises an encryption key list for the storage of encryption keys.

In an embodiment of the invention, the system comprises means for generating an index on a random basis or on the basis of a predetermined algorithm.

The invention provides the advantage that the encryption keys themselves are not transmitted between the systems at all. The invention makes it possible to identify the user in the target system with a certainty and at the same time to ascertain the authenticity of the systems involved in a remote session.

### LIST OF ILLUSTRATIONS

In the following, the invention will be described in detail by the aid of a few examples of its embodiments, wherein

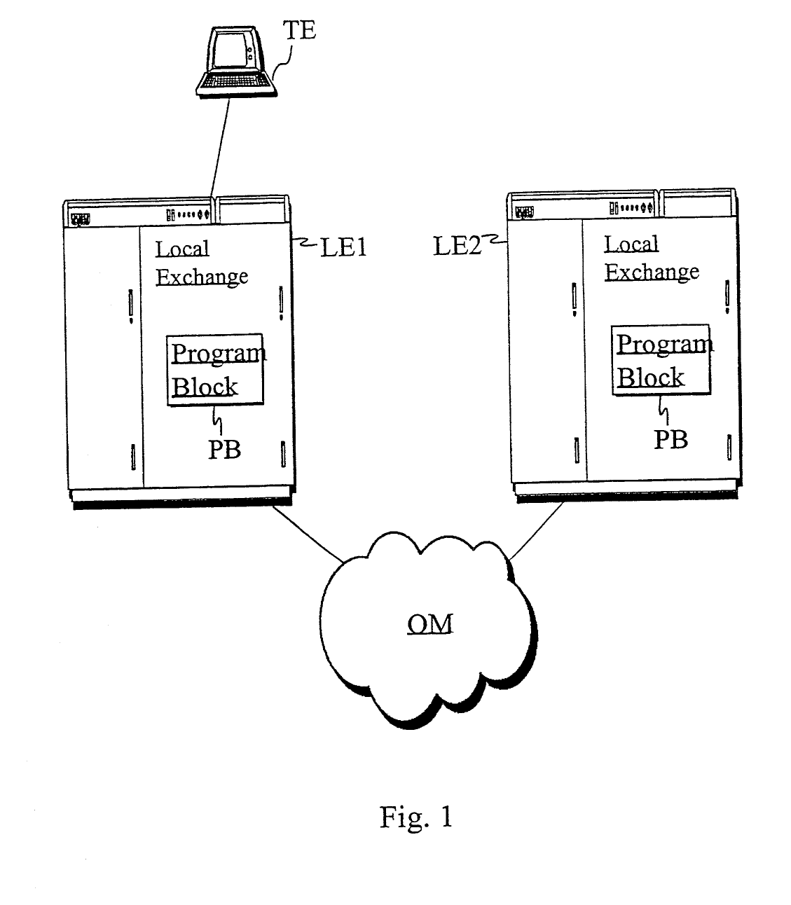

FIG. 1 presents a preferred system in which the method of the invention can be implemented,

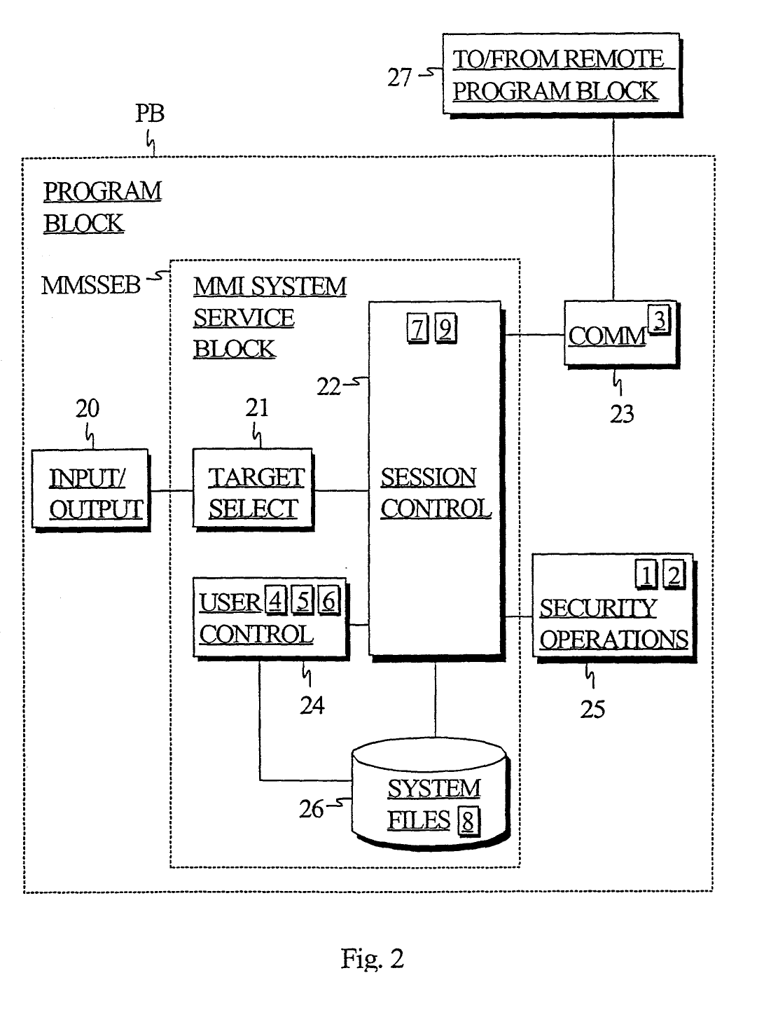

FIG. 2 presents a program block according to the invention, connected to a telephone exchange, and

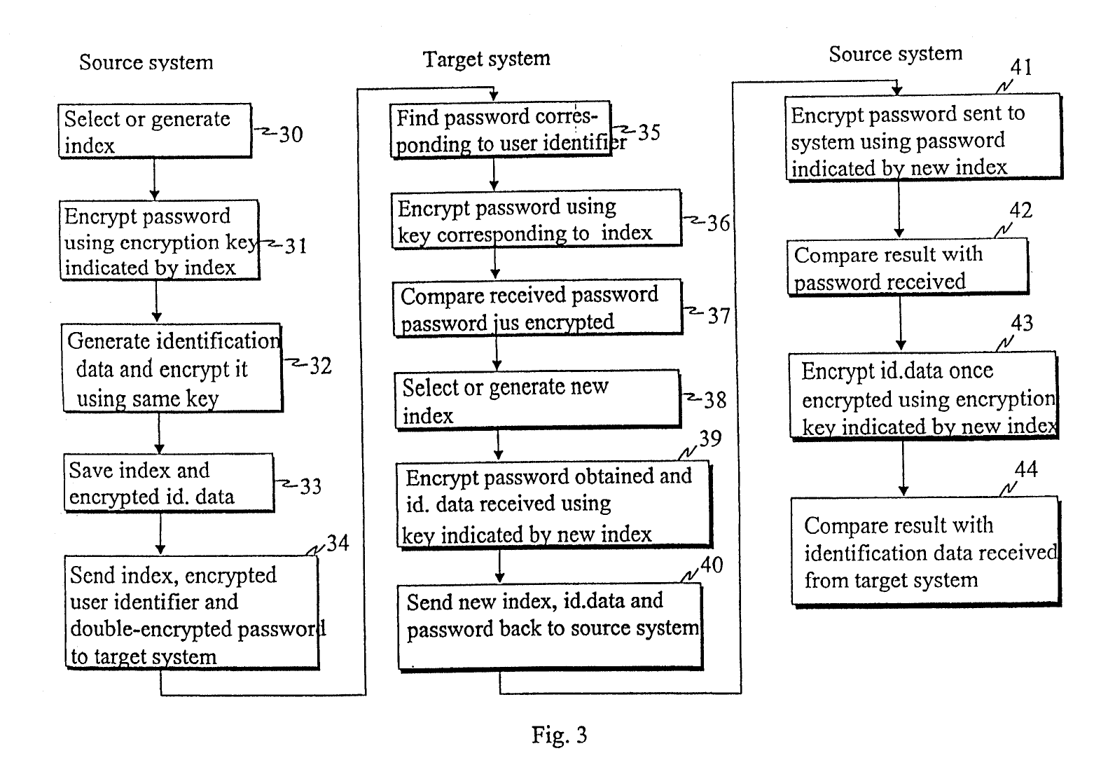

FIG. 3 presents a preferred example of a flow diagram according to the invention.

### DETAILED DESCRIPTION OF THE INVENTION

The system illustrated in FIG. 1 comprises an operation and maintenance network OM, a source system LE1, a target system LE2 and a workstation TE. The source system LE1 and the target system LE2 are preferably telephone exchanges. The telephone exchange is e.g. a DX200 manufactured by the applicant. The workstation TE is connected to the source system LE1, and it is possible to set up remote sessions from the workstation via the source system to the target system LE2. A remote session is established via the operation and maintenance network OM. The workstation may be an ordinary PC computer or equivalent, comprising a display and a keyboard by means of which the user can interactively transmit information with the operation and maintenance network OM.

In addition, each exchange comprises a program block PB, which is a certain aggregate of software and peripherals in the DX200 switching center that the operator can use to execute operation control functions in the operation and maintenance network OM. In practice, the program block PB is an interface between the user and the machine or telephone exchange, allowing the user to connect to the system and give it commands. A more detailed description of this block will be given in conjunction with FIG. 2. The system presented in FIG. 1 is a preferred example of a possible system in which the method of the invention can be implemented.

FIG. 2 presents a more detailed illustration of the structure and operation of the program block PB. The program block may comprise other components in addition to those shown in FIG. 2. The program block comprises an operation control block MMSSEB (Man Machine Interface System Service Block). The operation control block is connected to an input and output service block 20, which provides input and output system services to the other operation control blocks. Via block 20, the operation control block is connected to external peripherals, such as a display, a keyboard, a printer and a storage device. The operation control block is also connected to a communication block 23 and a security operations block 25.

In addition, the operation control block MMSSEB, shown in FIG. 2, comprises a target selection block 21, which is used to select the system to which the user wishes to set up a session. In practice, the system may be the local system, i.e. the source system to which the user's workstation is connected, or it may be a remote system, i.e. a target system to which a connection is established via the operation and maintenance network.

The user's session is controlled by a session control block 22, which communicates with the target selection block 21, the communication block 23 and the user control block 24. The session control block controls the session on the basis of commands given by the user. The user control block provides user identification and authority verification services, among other things. Via the communication block, the operation control block MMSSEB establishes remote connections to the operation control blocks in other systems, e.g. telephone exchanges, as directed by the target selection block. In practice, the communication block acts as an interface and a buffer between the source and target systems.

The communication block 23 comprises a program block 3 which is used to transmit information between different program blocks or systems. The session control block 22 comprises means 7 for generating identification data and for adding time data to the identification data. Means 7 consist of e.g. a program block that is able to determine the time data and make it part of the identification data. The identification data can be utilized in the identification of the parties between which information is to be transmitted. The time data is determined e.g. from the clock of the larger system comprising the operation control block MMSSEB. The session control block additionally comprises a program block 9 which is used to generate an index on a random basis or on the basis of a predetermined algorithm. The index is e.g. a numeric value referring to a given encryption key.

The user control block 24 and the session control block 22 further communicate with a system file block or database 26 storing the user data as well as the passwords, among other things. A possible encryption key list 8 used in conjunction with the encryption of information is stored e.g. in the database. The encryption key list comprises one or more encryption keys. Furthermore, the database may contain data indicating the manner in which encryption keys included in the encryption key list are generated. One of the functions of the session control block is to create indexes pointing at encryption keys included in the encryption key list. The indexes are generated e.g. on a random basis or on the basis of a given algorithm. The session control block additionally communicates with the security operations block 25. The security operations block contains the encryption algorithms needed for encryption and it performs the encryption of information upon request. An example of encryption algorithms applicable is the MDS. The encryption key list possibly associated with the encryption of information may alternatively be located in the security operations block.

The security operations block 25 comprises a program block 1 used to generate encryption keys. This program block 1 is e.g. a block containing an encryption algorithm. Program block 1 may comprise a given predetermined algorithm which produces encryption keys needed in the system. The security operations block also comprises a program block 2 which is used to encrypt information intended to be encrypted. Program blocks 1 and 2 together may form a larger program block.

The user control block 24 comprises a program block 4 which performs comparisons. The parties to be compared are e.g. encrypted passwords associated with a user identifier. The user control block further comprises a program block 5 which is used to approve a remote session to be set up. Moreover, the user control block comprises a program block 6 used to prevent the setup of a remote session. The setup of a remote session is prevented e.g. when program block 4 produces a negative comparison result. Together, program blocks 5 and 6 may form a larger program block.

Program block 27 means e.g. a program block PB or operation control block MMSSEB located in another system.

FIG. 3 presents a flow diagram representing a preferred example of a procedure according to the invention. According to block 30, an index is generated or selected. The index may be a random number within a given range or it may be generated using e.g. a secret algorithm. An index to be generated is subject to the requirement that it should point at an encryption key existing in the source and target systems. The encryption key is located e.g. on a special encryption key list. The user identifiers and the associated passwords have been stored in both the source system and the target system. In addition, in this example, an identical encryption key list has been stored in both systems. It is to be noted that an encryption key list need not necessarily be formed; instead, the encryption keys can be produced in other ways. According to block 31, the password associated with the user identifier is encrypted using the encryption key on the encryption key list that is indicated by the first index just generated. The encryption algorithm used is preferably a so-called one-way algorithm. An example of such algorithms is MDS. One-way algorithm means that the original input data cannot be deduced or constructed from the result of encryption.

To allow the systems to make sure of each other's authenticity, separate identification data is generated and encrypted using the same encryption key indicated by the first index, block 32. Identification data means e.g. time data obtained from the system clock. The essential point is that the identification data is of a changeable nature. The use of identification data is not obligatory, but in this example it is used. In this example, the identification data is sent together with the user data. Another possibility is to send the identification data separately from the user data at a suitable different time. According to block 33, the index and the encrypted identification data are stored in the source system for later use. The source system sends the user identifier, the first index, the encrypted identification data and password to the target system, block 34. As the password in this example has originally been saved in an encrypted form in the source and target systems, it has by now been encrypted twice using different keys. The index and the user identifier can be sent in an unencrypted form because their publicity does not impair the security of the system as the encryption key on the encryption key list corresponding to the index is stored in a protected file in the telephone exchange.

The target system receives the data transmitted and searches its own files to find the password corresponding to the user identifier, block 35. In other words, the password received is not processed in any way at this point. Having found the password in the file, the target system encrypts it using the encryption key indicated by the first index defined in the message received, block 36. As stated before, both the source system and the target system may contain identical encryption key lists. It is also possible that the source and target systems have no actual encryption key lists at all. In this case, the source and target systems contain identical means for the generation of encryption keys. Identical means here means e.g. that the source and target systems contain the same algorithm which can be used to generate encryption keys.

After this, the password received from the source system and the password just generated are compared with each other, block 37, and if the passwords match, then the procedure will go on to block 38. In block 38, a new, second index is selected or generated. The double-encrypted password received from the source system is now encrypted for a third time using the encryption key indicated by the second index, block 39. At the same time, the received identification data, which has already been encrypted once, is encrypted again using the encryption key indicated by the second index. After this, the target system sends the second index, the double-encrypted identification data and the triple-encrypted password back to the source system, block 40.

The source system receives the data sent by the target system, whereupon it encrypts the password and identification data initially sent to the target system, using the encryption key indicated by the second index. Thus, the password has now been encrypted three times, block 41. The encryption key corresponding to the second index can be found e.g. in an encryption key list. The triple-encrypted password thus obtained is compared with the likewise triple-encrypted password received from the target system, block 42. If the passwords coincide, then the user has been identified with certainty.

According to block 43, the identification data initially encrypted using the encryption key indicated by the first index and included in the encryption key list is encrypted again in the source system using the encryption key on the encryption key list indicated by the received second index. After this, the result is compared with the double-encrypted identification data received from the target system, block 44. If these identification data do not differ from each other, then it has been established with certainty that the target system is the system it was supposed to be.

The above-described operations regarding the transmission and encryption of the identification data ensure that the first message sent by the source system to the target system has not been captured by any outside user. Thus, the use of identification data makes it impossible for an outside party to falsely act as the target system in relation to the source system.

The invention is not restricted to the examples of its embodiments described above; instead, many variations are possible within the scope of the inventive idea defined in the claims.

1. Method for user identification and ascertainment of authenticity of parties in a telecommunication system comprising:
a telecommunication network (OM);
a source system (LE1) connected to the telecommunication network (OM);
a target system (LE2) connected to the telecommunication network (OM);
said method comprising the steps of:
storing user identifiers and associated passwords in the source system (LE1) and in the target system (LE2);
logging on into the source system (LE1) by entering a user identifier and a password corresponding to it;
identifying the user in the source system (LE1);
setting up a remote session to the target system (LE2);
characterized in that in that the method further comprises the steps of:
generating identical indexed encryption keys in the source system (LE1) and in the target system (LE2);
encrypting the password associated with the user identifier in the source system (LE1) using the encryption key indicated by a first index, and sending the encrypted data as well as the first index and the user identifier to the target system (LE2);
encrypting the password associated with the user identifier in the target system (LE2) using an encryption key indicated by the index received;
performing a first comparison between the received password and the password encrypted in the target system (LE2);
encrypting in the target system (LE2) the password received from the source system (LE1) using an encryption key indicated by a second index, and sending the encrypted data and the second index to the source system (LE1);
encrypting the encrypted password initially sent from the source system (LE1) to the target system (LE2) again using the encryption key indicated by the second index received from the target system (LE2);
performing a second comparison between the encrypted password received from the target system (LE2) and the password encrypted in the source system (LE1) using the encryption keys indicated by the first and second indexes; and
approving the setup of the remote session if the results of the comparisons are coincident.

2. Method as defined in claim 1, characterized in that the setup of the remote session is prevented if the results of the first or the second comparison are not coincident.

3. Method as defined in claim 1 or 2, characterized in that
separate identification data is generated;
the identification data is encrypted in the source system (LE1) using the encryption key indicated by the first index and the encrypted data is sent to the target system (LE2);
the identification data received from the source system (LE1) is encrypted in the target system (LE2) using the encryption key indicated by the second index and the encrypted data as well as the second index are sent back to the source system (LE1);
the identification data encrypted using the encryption key indicated by the first index which was initially sent to the target system (LE2) is encrypted again in the source system (LE1) using the encryption key indicated by the second index received from the target system (LE2);
a third comparison is performed between the encrypted identification data received from the target system (LE2) and the identification data just encrypted in the source system (LE1); and
the setup of the remote session is approved if the result of the comparison is coincident.

4. Method as defined in claim 3, characterized in that the setup of the remote session is prevented if the result of the third comparison is not coincident.

5. Method as defined in any one of the preceding claims 1-4, characterized in that
the identification data is sent simultaneously with the user data; or
the identification data is sent in separation from the user data.

6. Method as defined in any one of the preceding claims 1-5, characterized in that time data and/or data individualizing the source system is added to the identification data.

7. Method as defined in any one of the preceding claims 1-6, characterized in that the encryption keys are generated using a certain predetermined algorithm.

8. Method as defined in any one of the preceding claims 1-7, characterized in that the encryption keys are stored on a special encryption key list.

9. Method as defined in any one of the preceding claims 1-8, characterized in that the index is generated on a random basis or on the basis of a predetermined algorithm.

10. Method as defined in any one of the preceding claims 1-9, characterized in that a one-way encryption algorithm is used for the encryption of data in the source system (LE1) and in the target system (LE2).

11. Method as defined in any one of the preceding claims 1-10, characterized in that the telecommunication system is a telephone exchange system.

12. Method as defined in-any one of the preceding claims 1-11, characterized in that the source system (LE1) and/or the target system (LE2) are telephone exchanges.

13. Method as defined in any one of the preceding claims 1-12, characterized in that the telecommunication network (OM) is an operation and maintenance network.

14. System for user identification and ascertainment of authenticity of parties in a telecommunication system comprising:
a telecommunication network (OM);
a source system (LE1) connected to the telecommunication network (OM);
a target system (LE2) connected to the telecommunication network (OM);
in which system it is possible to store user identifiers and associated passwords in the source system (LE1) and in the target system (LE2), log on into the source system (LE1) by entering a user identifier and a password corresponding to it, identify the user in the source system (LE1) and set up a remote session to the target system (LE2);
characterized in that the system comprises:
means (1) for generating identical indexed encryption keys in the source system (LE1) and in the target system (LE2);
means (2) for encrypting data in the source and target systems using an encryption key indicated by an index;
means (3) for transmitting data between the source and target systems;
means (4) for performing a comparison in the source and target systems;
means (5) for approving the setup of a remote session.

15. System as defined in claim 14, characterized in that the system comprises means (6) for preventing the setup of a remote session.

16. Method as defined in claim 14 or 15, characterized in that the system comprises means (7) for generating identification data and adding time data and/or data individualizing the source system to the identification data.

17. System as defined in any one of the preceding claims 14-16, characterized in that the system comprises an encryption key list (8) for the storage of encryption keys.

18. System as defined in any one of the preceding claims 14-17, characterized in that the system comprises means (9) for generating an index on a random basis or on the basis of a predetermined algorithm.

19. System as defined in any one of the preceding claims 14-18, characterized in that the telecommunication system is a telephone exchange system.

20. System as defined in any one of the preceding claims 14-19, characterized in that the source system (LE1) and/or the target system (LE2) are telephone exchanges.

21. System as defined in any one of the preceding claims 14-20, characterized in that the telecommunication network (OM) is an operation and maintenance network.
